(19) United States
(12) Patent Application Publication
(10) Pub. No.: US 2025/0019497 A1
(43) Pub. Date: Jan. 16, 2025

(54) THERMALLY CONDUCTIVE SILICONE RUBBER COMPOSITION

(71) Applicant: DOW SILICONES CORPORATION, Midland, MI (US)

(72) Inventors: Rui WANG, Shanghai (CN); Yan ZHENG, Shanghai (CN); Yusheng CHEN, Shanghai (CN); Zhihai ZHANG, Shanghai (CN); Yi GUO, Shanghai (CN)

(21) Appl. No.: 18/687,324

(22) PCT Filed: Aug. 25, 2022
(86) PCT No.: PCT/CN2022/114896

§ 371 Date: Feb. 28, 2024

(30) Foreign Application Priority Data
Aug. 30, 2021 (WO) PCT/CN2021/115214

(51) Int. Cl. C08G 77/04; C08G 77/00; C08G 77/08; C08K 3/22; C08K 3/28; C08K 3/38; C08K 5/05; C08K 5/5419; C08K 9/06

(52) U.S. Cl. CPC C08G 77/045; C08G 77/08; C08G 77/70; C08K 3/22; C08K 5/05; C08K 5/5419; C08K 9/06; C08K 2003/2227; C08K 2003/282; C08K 2003/385; C08K 2201/001; C08K 2201/005

(57) ABSTRACT

Provided are hydrosilylation (addition) curable thermally conductive silicone rubber compositions containing high levels (e.g., greater than 80 wt. %) of thermally conductive fillers, a method for their preparation, and cured silicone-based products made from the compositions which have a thermal conductivity of at least 1.5 W/mK whilst retaining adequate physical properties such as tensile strength and elasticity. The use of such materials is also disclosed.

The present disclosure relates to hydrosilylation (addition) curable thermally conductive silicone rubber compositions containing high levels (e.g., greater than 80 wt. %) of thermally conductive fillers, a method for their preparation and to cured silicone-based products made from the compositions which have a thermal conductivity of at least 1.5 W/mK whilst retaining adequate physical properties such as tensile strength and elasticity. The present disclosure also extends to uses for such materials.

The properties of cured silicone-based products including organosiloxane elastomers make them desirable for a variety of end use applications including in the field of electronics. Compositions which generate the cured silicone-based products may, for example, be used to coat and when cured encapsulate solid state electronic devices such as time transistors and integrated circuits and the circuit boards on which these devices are often mounted to protect them from contact with moisture, corrosive materials and other impurities present in the environment in which these devices operate. However, while the organosiloxane compositions and the resulting cured silicone-based products effectively protect solid state devices from materials that can adversely affect their operation, they typically do not possess the thermal conductivity required to dissipate the large amounts of heat generated during their operation.

One method for increasing heat dissipation is to increase the thermal conductivity of the materials used to coat or encapsulate the solid-state devices by addition of thermally conductive fillers (sometimes referred to as heat conductive fillers) such as metal powders e.g., silver, nickel and copper and carbonaceous powders such as carbon blacks, graphite powders and/or carbon fibres to the coating or encapsulating material. However, such compositions may suffer from a variety of problems not least because of the high levels of such fillers required in order to generate high thermal conductivities of e.g., at least 1.5 W/mK. Such high thermal conductivities are achieved by increasing the amount of the thermally conductive fillers in the respective compositions, but the presence of such fillers in amounts of say greater than 75 or 80 weight % (wt. %) of the composition generally result in the pre-cured compositions having significantly increased viscosities causing impaired handling characteristics and additionally, upon cure, result in cured silicone-based products with poor physical properties as the vast majority of thermally conductive fillers are not reinforcing. Whilst such cured silicone-based products may be acceptable for some applications, industry is increasingly demanding compositions for the generation of cured materials which have both
(i) desired high levels of thermal conductivity, and
(ii) required levels of physical properties,
   whereas previously one might expect either one or the other. Solutions have been identified for (i) but at the expense of adequate physical properties. For example, the high viscosity of pre-cured compositions due to the level of thermally conductive filler present can be avoided by dilution of the compositions with non-reactive silicones or organic solvents, but this has been found to result in compatibility problems with the diluents bleeding out of the subsequently cured silicone-based products with time and furthermore, such products historically have not satisfied the physical property demands of the customer. Similarly the physical properties e.g., tensile strength and elasticity of cured materials with such high levels of the thermally conductive, non-reinforcing filler are relatively poor and/or inconsistent when compared with silicone elastomers containing optimised amounts of reinforcing fillers etc. consequently limiting their potential uses because without such physical properties the capability of the cured silicone material to perform over a long period of time in many preferred applications for such materials e.g., as gaskets, encapsulants or in shock isolation pads as such poor results can lead to failure thereof.

Other physical properties such as compression set can also be impaired. The compression set (the permanent deformation remaining after removal of a force when a material is compressed to a specific deformation, for a specified time, at a specific temperature) of a cured silicone material comprising high levels of thermally conductive fillers is generally poor and will deteriorate further over time. Consequently, the cured silicone material increasingly loses its ability to return to a thickness approaching its original thickness and thereby reduces the capability of the cured silicone material to perform over a long period of time.

There is provided herein a thermally conductive silicone rubber composition, which comprises the following components:
a) a polydiorganosiloxane having a degree of polymerisation of at least 2,500 calculated from the number average molecular weight determined by gel permeation chromatography and at least two unsaturated groups per molecule, which unsaturated groups are selected from alkenyl or alkynyl groups;
b) an organosilicon compound having at least two, alternatively at least three Si—H groups per molecule,
c) at least one thermally conductive filler with a volume median particle diameter size 0.1-100 micrometers (μm) measured by laser diffraction particle size analysis in an amount of from 80 to 95 wt. % of the composition;
d) an organopolysiloxane filler treating agent having a degree of polymerisation of between 4 to 500 calculated from the number average molecular weight determined by gel permeation chromatography and comprising
   (i) at least one alkenyl group per molecule and
   (ii) at least one hydroxy group or at least one alkoxy group or a mixture of hydroxy and alkoxy groups per molecule;
in an amount of from 0.1-10% wt. of the composition; and
e) a hydrosilylation catalyst comprising or consisting of a platinum group metal or a compound thereof;
   wherein the total wt. % of the composition is 100 wt. %.

The compositions are hydrosilylation (addition) curable thermally conductive silicone rubber compositions.

It was surprisingly identified that the use of component (a) having a degree of polymerisation of at least 2,500, and consequently having a high viscosity and molecular weight in conjunction with a thermally conductive filler (component (c)) which is treated with a specific organopolysiloxane (component (d) was able to consistently achieve a hydrosilylation cured silicone rubber of high mechanical strength even when the composition contains very high amounts (80 to 95 wt. % of the composition) of thermally conductive filler(c).

There is provided herein an organopolysiloxane composition designed to both provide a cured silicone-based products with a high thermal conductivity of e.g., at least 1.5 W/mK (measured in accordance with ASTM D7896—hot disk method), whilst retaining sufficient physical properties (i.e., tensile strength of at least 2 MPa and elongation at break of at least 80% in accordance with ASTM D412).

The components of the Composition:

### Component (a)

Component (a) is a polydiorganosiloxane having a degree of polymerisation of at least 2,500, and at least two unsaturated groups per molecule, which unsaturated groups are selected from alkenyl or alkynyl groups.

Hence, each polydiorganosiloxane of component (a) has a degree of polymerisation of at least 2,500, alternatively at least 3,500, alternatively at least 4000, i.e., therefore has at least 2,500, alternatively at least 3,500, alternatively at least 4000, siloxy units, of formula (I):

R′ₐSiO_{(4-a)/2} (I)

The subscript “a” is 0, 1, 2 or 3.

Siloxy units may be described by a shorthand (abbreviated) nomenclature, namely—“M,” “D,” “T,” and “Q”, when R′ is for example, an independently selected substituted or unsubstituted hydrocarbyl group having from 1 to 18 carbon atoms, alternatively an alkyl group, typically a methyl group (further teaching on silicone nomenclature may be found in Walter Noll, Chemistry and Technology of Silicones, dated 1962, Chapter I, pages 1-9). The M unit corresponds to a siloxy unit where a=3, that is R′₃SiO_{1/2}; the D unit corresponds to a siloxy unit where a=2, namely R′₂SiO_{2/2}; the T unit corresponds to a siloxy unit where a=1, namely R′₁SiO_{3/2}; the Q unit corresponds to a siloxy unit where a=0, namely SiO_{4/2}. The polyorganosiloxane such as a polydiorganosiloxane of component (a) is substantially linear but may contain a proportion of branching due to the presence of T units (as previously described) within the molecule, hence the average value of a in structure (I) is about 2.

The unsaturated groups of component (a) may be positioned either terminally or pendently on the polydiorganosiloxane, or in both locations. The unsaturated groups of component (a) may be alkenyl groups or alkynyl groups as described above. Each alkenyl group, when present, may comprise for example from 2 to 30, alternatively 2 to 24, alternatively 2 to 20, alternatively 2 to 12, alternatively 2 to 10, and alternatively 2 to 6 carbon atoms. When present the alkenyl groups may be exemplified by, but not limited to, vinyl, allyl, methallyl, propenyl, and hexenyl and cyclohexenyl groups. Each alkynyl group, when present, may also have 2 to 30, alternatively 2 to 24, alternatively 2 to 20, alternatively 2 to 12, alternatively 2 to 10, and alternatively 2 to 6 carbon atoms. Examples of alkynyl groups may be exemplified by, but not limited to, ethynyl, propynyl, and butynyl groups. Preferred examples of the unsaturated groups of component (a) include vinyl, isopropenyl, allyl, and 5-hexenyl.

In formula (I), each R′, other than the unsaturated groups described above, is an independently selected substituted or unsubstituted hydrocarbyl group having from 1 to 18 carbon atoms. These may be individually selected from an aliphatic hydrocarbyl group, a substituted aliphatic hydrocarbyl group, an aromatic group or a substituted aromatic group. Each aliphatic hydrocarbyl group may be exemplified by, but not limited to, alkyl groups having from 1 to 20 carbons per group, alternatively 1 to 15 carbons per group, alternatively 1 to 12 carbons per group, alternatively 1 to 10 carbons per group, alternatively 1 to 6 carbons per group or cycloalkyl groups such as cyclohexyl. Specific examples of alkyl groups may include methyl, ethyl, propyl, pentyl, octyl, undecyl, and octadecyl groups, alternatively methyl and ethyl groups. Substituted aliphatic hydrocarbyl group are preferably non-halogenated substituted alkyl groups.

The aliphatic non-halogenated organyl groups are exemplified by, but not limited to alkyl groups as described above with a substituted group such as suitable nitrogen containing groups such as amido groups, imido groups; oxygen containing groups such as polyoxyalkylene groups, carbonyl groups, alkoxy groups and hydroxyl groups. Further organyl groups may include sulfur containing groups, phosphorus containing groups, boron containing groups. Examples of aromatic groups or substituted aromatic groups are phenyl groups and substituted phenyl groups with substituted groups as described above.

Component (a) may, for example, be selected from polydimethylsiloxanes, alkylmethylpolysiloxanes, alkylarylpolysiloxanes or copolymers thereof (where reference to alkyl means any suitable alkyl group, alternatively an alkyl group having two or more carbons) providing each polymer contains at least two unsaturated groups, typically alkenyl groups as described above and has a degree of polymerisation of at least 2,500. They may for example be trialkyl terminated, alkenyldialkyl terminated alkynyldialkyl terminated or may be terminated with any other suitable terminal group combination providing each polymer contains the required at least two unsaturated groups per molecule and a degree of polymerisation of at least 2,500.

Hence component (a) may, for the sake of example, be:

a dialkylalkenyl terminated polydimethylsiloxane, e.g. dimethylvinyl terminated polydimethylsiloxane; a dialkylalkenyl terminated dimethylmethylphenylsiloxane, e.g. dimethylvinyl terminated dimethylmethylphenylsiloxane; a trialkyl terminated dimethylmethylvinyl polysiloxane; a dialkylvinyl terminated dimethylmethylvinyl polysiloxane copolymer; a dialkylvinyl terminated methylphenylpolysiloxane, a dialkylalkenyl terminated methylvinylmethylphenylsiloxane; a dialkylalkenyl terminated methylvinyldiphenylsiloxane; a dialkylalkenyl terminated methylvinyl methylphenyl dimethylsiloxane; a trimethyl terminated methylvinyl methylphenylsiloxane; a trimethyl terminated methylvinyl diphenylsiloxane; or a trimethyl terminated methylvinyl methylphenyl dimethylsiloxane.

In each case component (a) has a degree of polymerisation (DP) of at least 2,500, alternatively at least 3,500, alternatively at least 4000. Polydiorganosiloxane polymers of this magnitude are generally referred to in the industry as polydiorganosiloxane gums, siloxane gums or silicone gums (hereafter referred to a silicone gum) because of their very high viscosity (at least 1,000,000 mPa·s at 25° C., often many millions mPa·s at 25° C.) and high molecular weight, and as a consequence high degrees of polymerisation (DPs) of e.g., at least 2500 given the DP is calculated from the number average molecular weight of a polymer. Because of the difficulty in measuring the viscosity of highly viscous fluids such as silicone gums, the gums tend to be defined by way of their Williams plasticity values as opposed to by viscosity. When component (a) is a silicone gum said gum has a Williams's plasticity of at least 30 mm/100 measured in accordance with ASTM D-926-08, alternatively at least 50 mm/100 measured in accordance with ASTM D-926-08, alternatively at least 100 mm/100 measured in accordance with ASTM D-926-08. Typically, silicone gums have a Williams's plasticity of from about 100 mm/100 to 300 mm/100 measured in accordance with ASTM D-926-08.

Number average molecular weight and weight average molecular weights of such polymers are typically determined by gel permeation chromatography using polystyrene standards. In the present disclosure number average molecular weight and weight average molecular weight values of the silicone gums used as component (a) herein were determined using a Waters 2695 Separations Module equipped with a vacuum degasser, and a Waters 2414 refractive index detector (Waters Corporation of MA, USA). The analyses were performed using certified grade toluene flowing at 1.0 mL/min as the eluent. Data collection and analyses were performed using Waters Empower GPC software.

The degree of polymerisation of the polymer was approximately the number average molecular weight of the polymer divided by 74 (the molecular weight of one component (I) depicted above). Typically, the alkenyl and/or alkynyl content, e.g. vinyl content of the polymer is from 0.01 to 3 wt. % for each polydiorganosiloxane containing at least two silicon-bonded alkenyl groups per molecule of component (a), alternatively from 0.01 to 2.5 wt. % of component (a), alternatively from 0.001 to 2.0 wt. %, alternatively from 0.01 to 1.5 wt. % of component (a) of the or each polydiorganosiloxane containing at least two unsaturated groups per molecule, which unsaturated groups are selected from alkenyl or alkynyl groups per molecule of component (a). The alkenyl/alkynyl content of component (a) is determined using quantitative infra-red analysis in accordance with ASTM E168.

Component (a) may be present in the composition in an amount of from 4 wt. % to about 19 to 20 wt. % of the composition, alternatively from 5 to about 19 or 20 wt. % of the composition, alternatively from 5 to 17.5 wt. % of the composition, alternatively from 7.5 to 17.5 wt. % of the composition. Typically, component (a) is present in an amount which is the difference between 100 wt. % and the cumulative wt. % of the other components/ingredients of the composition.

### Component (b)

Component (b) functions as a cross-linker and is provided in the form of an organosilicon compound having at least two, alternatively at least three Si—H groups per molecule. Component (b) normally contains three or more silicon-bonded hydrogen atoms so that the hydrogen atoms can react with the unsaturated alkenyl and/or alkynyl groups of polymer (a) to form a network structure therewith and thereby cure the composition. Some or all of Component (b) may alternatively have two silicon bonded hydrogen atoms per molecule when polymer (a) has greater than two unsaturated groups per molecule.

The molecular configuration of the organosilicon compound having at least two, alternatively at least three Si—H groups per molecule (b) is not specifically restricted, and it can be a straight chain, branched (a straight chain with some branching through the presence of T groups), cyclic or silicone resin based.

While the molecular weight of component (b) is not specifically restricted, the viscosity is typically from 5 to 50,000 mPa·s at 25° C. relying on either a Brookfield DV-III Ultra Programmable Rheometer for viscosities greater than or equal to 50,000 mPa·s, and a Brookfield DV 3T Rheometer for viscosities less than 50,000 mPa·s, in order to obtain a good miscibility with polymer (a). Silicon-bonded organic groups used in component (b) may be exemplified by alkyl groups such as methyl, ethyl, propyl, n-butyl, t-butyl, pentyl, hexyl; aryl groups such as phenyl tolyl, xylyl, or similar aryl groups; 3-chloropropyl, 3,3,3-trifluoropropyl, or similar halogenated alkyl group, preferred alkyl groups having from 1 to 6 carbons, especially methyl ethyl or propyl groups or phenyl groups. Preferably the silicon-bonded organic groups used in component (b) are alkyl groups, alternatively methyl, ethyl or propyl groups.

Examples of the organosilicon compound having at least two, alternatively at least three Si—H groups per molecule (b) include but are not limited to:
(a) trimethylsiloxy-terminated methylhydrogenpolysiloxane,
(b) trimethylsiloxy-terminated polydimethylsiloxane-methylhydrogensiloxane,
(c) dimethylhydrogensiloxy-terminated dimethylsiloxane-methylhydrogensiloxane copolymers,
(d) dimethylsiloxane-methylhydrogensiloxane cyclic copolymers,
(e) copolymers and/or silicon resins consisting of (CH₃)₂HSiO_{1/2} units, (CH₃)₃SiO_{1/2} units and SiO_{4/2} units,
(f) copolymers and/or silicone resins consisting of (CH₃)₂HSiO_{1/2} units and SiO_{4/2} units,
(g) Methylhydrogensiloxane cyclic homopolymers having between 3 and 10 silicon atoms per molecule;
alternatively, component B, the cross-linker, may be a filler, e.g., silica treated with one of the above, and mixtures thereof.

In one embodiment the Component (b) is selected from a methylhydrogenpolysiloxane capped at both molecular terminals with trimethylsiloxy groups; a copolymer of a methylhydrogensiloxane and a dimethylsiloxane capped at both molecular terminals with trimethylsiloxy groups; dimethylsiloxane capped at both molecular terminals with dimethylhydrogensiloxy groups; a copolymer of a methylhydrogensiloxane and a dimethylsiloxane capped at both molecular terminals with dimethylhydrogensiloxy groups.

The cross-linker (b) is generally present in the thermally conductive silicone rubber composition such that the molar ratio of the total number of the silicon-bonded hydrogen atoms in component (b) to the total number of alkenyl and/or alkynyl groups in polymer (a) and in component (d) is from 0.5:1 to 20:1. When this ratio is less than 0.5:1, a well-cured composition will not be obtained. When the ratio exceeds 20:1, there is a tendency for the hardness of the cured composition to increase when heated. Preferably in an amount such that the molar ratio of silicon-bonded hydrogen atoms of component (b) to alkenyl/alkynyl groups, alternatively alkenyl groups of component (a) and component (d) ranges from 0.7:1.0 to 5.0:1.0, preferably from 0.9:1.0 to 2.5:1.0, and most preferably from 0.9:1.0 to 2.0:1.0.

The silicon-bonded hydrogen (Si—H) content of component (b) is determined using quantitative infra-red analysis in accordance with ASTM E168. In the present instance the silicon-bonded hydrogen to alkenyl (vinyl) and/or alkynyl ratio is important when relying on a hydrosilylation cure process. Generally, this is determined by calculating the total weight % of alkenyl groups in the composition, e.g., vinyl [V] and the total weight % of silicon bonded hydrogen [H] in the composition and given the molecular weight of hydrogen is 1 and of vinyl is 27 the molar ratio of silicon bonded hydrogen to vinyl is 27[H]/[V].

Typically, dependent on the number of unsaturated groups in component (a) and component (d) as well as the number of Si—H groups in component (b), component (b) will be present in an amount of from 0.1 to 10 wt. % of the thermally conductive silicone rubber composition, alternatively 0.1 to 7.5 wt. % of the thermally conductive silicone rubber composition, alternatively 0.5 to 7.5 wt. %, further alternatively from 0.5% to 5 wt. % of the thermally conductive silicone rubber composition.

### Component (c)

Component (c) is at least one thermally conductive filler with a volume median particle diameter D(v,0.5) of between 0.1-100 micrometers (μm) in an amount of from 80 to 95 wt. % of the composition.

The volume median particle diameter D(v,0.5) is the particle diameter value for a D₅₀ particle size distribution (or median particle size distribution) where 50% of the distribution is above said value and 50% is below said value. The thermally conductive filler (c) may be a single thermally conductive filler or a combination of two or more thermally conductive fillers that differ in at least one property such as particle shape, volume median particle diameter, particle size distribution, and type of filler. The volume median particle diameter D(v,0.5) values herein were taken from supplier datasheets and/or were measured by laser diffraction particle size analysis using a Malvern Mastersizer 2000 with Hydro 2000MU dispersion unit. The parameters relied upon were refractive index (R.I.) of particle: 1.78/0.1; dispersant: water (1.33); obscuration: ˜10%; inner stirring speed: 3000 rpm.

Samples were prepared before analysis by mixing 0.5 g fillers+25 ml water, shake and put into Hydro 2000MU dispersion unit with 2 min inner sonication.

Any suitable thermally conductive fillers may be utilised as component (c). Examples include: metals e.g., bismuth, lead, tin, antimony, indium, cadmium, zinc, silver, copper, nickel, aluminum, iron and silicon metal;
alloys e.g., alloys of one or more of bismuth, lead, tin, antimony, indium, cadmium, zinc, silver, aluminum, iron and/or silicon; for example, Fe—Si alloy, Fe—Al alloy, Fe—Si—Al alloy, Fe—Si—Cr alloy, Fe—Ni alloy, Fe—Ni—Co alloy, Fe—Ni—Mo alloy, Fe—Co alloy, Fe—Si—Al—Cr alloys, Fe—Si—B alloy and Fe—Si—Co—B alloy;
ferrites, Mn—Zn ferrite, Mn—Mg—Zn ferrite, Mg—Cu—Zn ferrite, Ni—Zn ferrite, and a Ni—Cu—Zn ferrite and Cu—Zn ferrite;
Metal oxides such as, aluminium oxide (alumina), zinc oxide, silicon oxide, magnesium oxide, beryllium oxide, chromium oxide and titanium oxide;
metal hydroxides such as magnesium hydroxide, aluminum hydroxide, barium hydroxide and calcium hydroxide;
metal nitrides, such as boron nitride, aluminum nitride and silicon nitride;
metal carbides such as silicon carbide, include boron carbide and titanium carbide; and
metal silicides such as magnesium silicide, titanium silicide, silicide, zirconium, tantalum silicide, niobium silicide, chromium silicide, and a tungsten silicide and molybdenum silicide.

The thermally conductive filler may be a mixture of two or more of the above. In some embodiments, combinations of metallic and inorganic fillers, may be used, for example a combination of aluminium and aluminium oxide fillers; a combination of aluminium and zinc oxide fillers; or a combination of aluminium, aluminium oxide, and zinc oxide fillers.

Of the above, aluminium oxide, aluminum hydroxide, aluminium nitride, boron nitride and mixtures thereof are preferred.

The shape of the thermally conductive filler particles is not specifically restricted, e.g., they may be powders and/or fibers, however, rounded or spherical particles may prevent viscosity increase to an undesirable level upon high loading of the thermally conductive filler in the composition and as such are preferred. The volume median particle diameter and D₅₀ particle size distribution of the thermally conductive filler will depend on various factors including the type of thermally conductive filler selected and the exact amount added to the curable composition, as well as the bondline thickness of the device in which the cured silicone-based product of the composition will be used. In some particular instances, the thermally conductive filler may have a volume median particle diameter ranging from 0.1-100 micrometers (μm) measured by laser diffraction particle size analysis, alternatively 0.1 micrometre to 80 micrometres, alternatively 0.1 micrometre to 50 micrometres. The thermally conductive silicone rubber compositions as described herein comprises from 80 wt. % to 95 wt. %, alternatively from e.g., 85 wt. % to 95 wt. % thermally conductive filler (c).

The cured silicone-based products resulting from the thermally conductive silicone rubber composition comprising at least 80 wt. % thermally conductive filler (c) described herein will have a high thermal conductivity of at least 1.5 W/mK, measured in accordance with ASTM D7896—hot disk method.

The thermal conductivity of the cured silicone-based products will depend on the thermally conductive filler(s) utilised. In the case of less conductive thermally conductive fillers (c) such as aluminium oxide and aluminium hydroxide when present in an amount of 80 wt. % of the composition thermal conductivity of the product will be typically between 1.5 W/mK and 2.0 W/mK, (ASTM D7896—hot disk method) and as such the composition may require up to about 85 wt. % of these thermally conductive fillers, for the cured silicone-based products to have a thermal conductivity of at least 2.0 W/mK (ASTM D7896—hot disk method).

However, cured silicone-based products from the thermally conductive silicone rubber composition herein comprising at least 80 wt. % thermally conductive filler (c) wherein the fillers are metal nitrides e.g., boron nitride aluminum nitride and silicon nitride, will have significantly higher thermal conductivities e.g., at least 2.0 W/mK (ASTM D7896—hot disk method).

One advantage herein when using such fillers in combination with the compositions herein result in said cured silicone-based products retaining their physical properties such as tensile strength and elongation at break.

### Component (d)

Component (d) of the composition herein is utilised as a filler treating agent comprising an organopolysiloxane having a degree of polymerisation of between 4 to 500 and comprising
(i) at least one alkenyl group per molecule and
(ii) at least one hydroxy group or at least one alkoxy group or a mixture of hydroxy and alkoxy groups per molecule.

Hence, each organopolysiloxane of component (d) has a degree of polymerisation of between 4 to 500, i.e., therefore has between 4 to 500 siloxy units of formula (I) as described with respect to component (a):

R′ₐSiO_{(4-a)/2} (I)

The subscript “a” is 0, 1, 2 or 3.

The unsaturated group(s) of component (d) may be positioned either terminally or pendently on the polydiorganosiloxane, or when greater than one (>1)) is present in both locations. The unsaturated groups of component (d) may be the alkenyl groups or alkynyl groups as described above with respect to component (a).

In component (d) there is/are also at least one hydroxy group or at least one alkoxy group or a mixture of hydroxy and alkoxy groups per molecule. When present the alkoxy groups may have from 1 to 20 carbons per group, alternatively 1 to 15 carbons per group, alternatively 1 to 12 carbons per group, alternatively 1 to 10 carbons per group, alternatively 1 to 6 carbons per group with methoxy groups ethoxy groups, propoxy groups butoxy groups, pentoxy groups and/or hexoxy groups preferred. The organopolysiloxane of component (d) may be linear or branched.

In component (d) referring again to formula (I), each R′, other than the unsaturated groups described above, and the at least one hydroxy group or at least one alkoxy group or a mixture of hydroxy and alkoxy groups per molecule, is independently selected from the same aliphatic hydrocarbyl groups, substituted aliphatic hydrocarbyl groups, aromatic groups or substituted aromatic groups described above with respect to component (a).

Component (d) may be selected from polydimethylsiloxanes, alkylmethylpolysiloxanes, alkylarylpolysiloxanes or copolymers thereof (where reference to alkyl means any suitable alkyl group, alternatively an alkyl group having two or more carbons) providing they have a degree of polymerisation of between 4 to 500 and comprise
(i) at least one alkenyl group per molecule and
(ii) at least one hydroxy group or at least one alkoxy group or a mixture of hydroxy and alkoxy groups per molecule.

The said alkenyl groups, hydroxy group(s) and alkoxy group(s) may be pendent or terminal groups. In one preferred alternative the unsaturated groups, hydroxy group(s) and alkoxy group(s) are terminal groups.

For the sake of example, component (d) herein may be a linear or branched polydimethylsiloxane having one dimethylalkenyl termination per molecule and one trialkoxy termination per molecule or a hydroxyldialkyl termination per molecule such as M^{vi}D_{f}Si(OMe)₃ which may be alternatively written as

(CH₂═CH)(CH₃)₂SiO[(CH₃)₂SiO]_{f}Si(OCH₃)₃

Wherein f is an integer such that the degree of polymerisation is from 4 to 500, alternatively f is an integer such that the degree of polymerisation is from 4 to 250, f is an integer such that the degree of polymerisation is from 4 to 150, alternatively f is an integer such that the degree of polymerisation is from 4 to 100. An example thereof being when f is 25, i.e. M^{vi}D₂₅Si(OMe)₃ otherwise written as

(CH₂═CH)(CH₃)₂SiO[(CH₃)₂SiO]₂₅SiO(CH₃)₃

An alternative example of component (d) may be a polydimethylmethylvinylsiloxane polymer or a polymethylvinylsiloxane polymer having a degree of polymerisation of from 4 to 500 with dialkylhydroxy termination or dialkylmethoxy termination such as the following

R¹(CH₃)₂SiO[(CH₃)₂SiO]ₘ[(CH₂═CH)(CH₃)SiO]ₙSiO(CH₃)₃R¹

where R′ is hydroxy or alkoxyl, m is zero or an integer and n is an integer such that the degree of polymerisation is from 4 to 500, alternatively such that the degree of polymerisation is from 4 to 250, alternatively such that the degree of polymerisation is from 4 to 150, alternatively such that the degree of polymerisation is from 4 to 100, alternatively such that the degree of polymerisation is from 4 to 50, for example where m+n=4 to 17.

In each case component (d) has a degree of polymerisation of between 4 to 500 and comprising
(i) at least one alkenyl group per molecule and
(ii) at least one hydroxy group or at least one alkoxy group or a mixture of hydroxy and alkoxy groups per molecule.

A degree of polymerisation of between 4 to 500 which means the viscosity is going to be a minimum of about 20 mPa·s at 25° C. and the number average molecular weight of the composition (Mw) is approximately at least about 300. Molecular weight values may again be determined by gel permeation chromatography but polymers at the lower end of the range e.g., having a DP of from about 4 to 20 can be analysed by gas chromatography—mass spectroscopy (GC-MS).

Component (d) is present in the composition herein in an amount of 0.1-10 wt. %, alternatively in an amount of from 0.1-5 wt. % of the composition, alternatively in an amount of from 0.25-5 wt. % of the composition, alternatively in an amount of from 0.25-2.5 wt. % of the composition.

### Component (e)

Component (e) of the thermally conductive silicone rubber composition, is a hydrosilylation catalyst comprising or consisting of a platinum group metal or a compound thereof. These are usually selected from catalysts of the platinum group of metals (platinum, ruthenium, osmium, rhodium, iridium and palladium), or a compound of one or more of such metals. Alternatively, platinum and rhodium compounds are preferred due to the high activity level of these catalysts in hydrosilylation reactions, with platinum compounds most preferred. In a hydrosilylation (or addition) reaction, a hydrosilylation catalyst such as component (e) herein catalyses the reaction between an unsaturated group, usually an alkenyl group e.g., vinyl with Si—H groups.

The hydrosilylation catalyst of component (e) can be a platinum group metal, a platinum group metal deposited on a carrier, such as activated carbon, metal oxides, such as aluminum oxide or silicon dioxide, silica gel or powdered charcoal, or a compound or complex of a platinum group metal. Preferably the platinum group metal is platinum.

Examples of preferred hydrosilylation catalysts of component (e) are platinum based catalysts, for example, platinum black, platinum oxide (Adams catalyst), platinum on various solid supports, chloroplatinic acids, e.g. hexachloroplatinic acid (Pt oxidation state IV) (Speier catalyst), chloroplatinic acid in solutions of alcohols e.g. isooctanol or amyl alcohol (Lamoreaux catalyst), and complexes of chloroplatinic acid with ethylenically unsaturated compounds such as olefins and organosiloxanes containing ethylenically unsaturated silicon-bonded hydrocarbon groups, e.g. tetra-vinyl-tetramethylcyclotetrasiloxane-platinum complex (Ashby catalyst). Soluble platinum compounds that can be used include, for example, the platinum-olefin complexes of the formulae (PtCl₂.(olefin)₂ and H(PtCl₃.olefin), preference being given in this context to the use of alkenes having 2 to 8 carbon atoms, such as ethylene, propylene, isomers of butene and of octene, or cycloalkanes having 5 to 7 carbon atoms, such as cyclopentene, cyclohexene, and cycloheptene. Other soluble platinum catalysts are, for the sake of example a platinum-cyclopropane complex of the formula (PtCl₂C₃H₆)₂, the reaction products of hexachloroplatinic acid with alcohols, ethers, and aldehydes or mixtures thereof, or the reaction product of hexachloroplatinic acid and/or its conversion products with vinyl-containing siloxanes such as methylvinylcyclotetrasiloxane in the presence of sodium bicarbonate in ethanolic solution—. Platinum catalysts with phosphorus, sulfur, and amine ligands can be used as well, e.g. (Ph₃P)₂PtCl₂; and complexes of platinum with vinylsiloxanes, such as sym-divinyltetramethyldisiloxane.

Hence, specific examples of suitable platinum-based catalysts of component (e) include
(i) complexes of chloroplatinic acid with organosiloxanes containing ethylenically unsaturated hydrocarbon groups are described in U.S. Pat. No. 3,419,593;
(ii) chloroplatinic acid, either in hexahydrate form or anhydrous form;
(iii) a platinum-containing catalyst which is obtained by a method comprising reacting chloroplatinic acid with an aliphatically unsaturated organosilicon compound, such as divinyltetramethyldisiloxane;
(iv) alkene-platinum-silyl complexes as described in U.S. Pat. No. 6,605,734 such as (COD)Pt(SiMeCl₂)₂ where “COD” is 1,5-cyclooctadiene; and/or
(v) Karstedt's catalyst, a platinum divinyl tetramethyl disiloxane complex typically containing about 1 wt. % of platinum typically in a vinyl siloxane polymer. Solvents such as toluene and the like organic solvents have been used historically as alternatives but the use of vinyl siloxane polymers by far the preferred choice. These are described in U.S. Pat. Nos. 3,715,334 and 3,814,730. In one preferred embodiment component (e) may be selected from co-ordination compounds of platinum. In one embodiment hexachloroplatinic acid and its conversion products with vinyl-containing siloxanes, Karstedt's catalysts and Speier catalysts are preferred.

The catalytic amount of the hydrosilylation catalyst is generally between 0.01 ppm, and 10,000 parts by weight of platinum-group metal, per million parts (ppm), based on the weight of the composition; alternatively, between 0.01 and 5000 ppm; alternatively, between 0.01 and 3,000 ppm, and alternatively between 0.01 and 1,000 ppm. In specific embodiments, the catalytic amount of the catalyst may range from 0.01 to 1,000 ppm, alternatively 0.01 to 750 ppm, alternatively 0.01 to 500 ppm and alternatively 0.01 to 100 ppm of metal based on the weight of the composition. The ranges may relate solely to the metal content within the catalyst or to the catalyst altogether (including its ligands) as specified, but typically these ranges relate solely to the metal content within the catalyst. The catalyst may be added as a single species or as a mixture of two or more different species. Typically, dependent on the form/concentration in which the catalyst is provided e.g., in a polymer or solvent, the amount of component (e) present will be within the range of from 0.001 to 3.0 wt. % of the composition, alternatively from 0.001 to 1.5 wt. % of the composition, alternatively from 0.01-1.5 wt. %, alternatively 0.01 to 0.1.0 wt. %, of the thermally conductive silicone rubber composition.

### Additional Optional Components

Additional optional components may be present in the thermally conductive silicone rubber composition as hereinbefore described depending on the intended final use thereof. Examples of such optional components include cure inhibitors, compression set additives, reinforcing fillers, pigments and/or coloring agents, and other additional additives such as metal deactivators, mold release agents, UV light stabilizers, bactericides, and mixtures thereof.

### Optional Hydrosilylation Reaction Inhibitors

The thermally conductive silicone rubber composition as described herein may also comprise one or more optional hydrosilylation reaction inhibitors. Hydrosilylation reaction inhibitors are used, when required, to prevent or delay the hydrosilylation reaction inhibitors curing process especially during storage. The optional hydrosilylation reaction inhibitors of platinum-based catalysts are well known in the art and include hydrazines, triazoles, phosphines, mercaptans, organic nitrogen compounds, acetylenic alcohols, silylated acetylenic alcohols, maleates, fumarates, ethylenically or aromatically unsaturated amides, ethylenically unsaturated isocyanates, olefinic siloxanes, unsaturated hydrocarbon monoesters and diesters, conjugated ene-ynes, hydroperoxides, nitriles, and diaziridines. Alkenyl-substituted siloxanes as described in U.S. Pat. No. 3,989,667 may be used, of which cyclic methylvinylsiloxanes are preferred.

One class of known hydrosilylation reaction inhibitors are the acetylenic compounds disclosed in U.S. Pat. No. 3,445,420. Acetylenic alcohols such as 2-methyl-3-butyn-2-ol constitute a preferred class of inhibitors that will suppress the activity of a platinum-containing catalyst at 25° C. Compositions containing these inhibitors typically require heating at temperature of 70° C. or above to cure at a practical rate.

Examples of acetylenic alcohols and their derivatives include 1-ethynyl-1-cyclohexanol (ETCH), 2-methyl-3-butyn-2-ol, 3-butyn-1-ol, 3-butyn-2-ol, propargyl alcohol, 1-phenyl-2-propyn-1-ol, 3,5-dimethyl-1-hexyn-3-ol, 1-ethynylcyclopentanol, 3-methyl-1-penten-4-yn-3-ol, and mixtures thereof. Derivatives of acetylenic alcohol may include those compounds having at least one silicon atom. When present, hydrosilylation reaction inhibitor concentrations may be as low as 1 mole of hydrosilylation reaction inhibitor per mole of the metal of catalyst (e) will, in some instances, still impart satisfactory storage stability and cure rate. In other instances, hydrosilylation reaction inhibitor concentrations of up to 500 moles of inhibitor per mole of the metal of catalyst are required. The optimum concentration for a given hydrosilylation reaction inhibitor in a given composition is readily determined by routine experimentation. Dependent on the concentration and form in which the hydrosilylation reaction inhibitor selected is provided/available commercially, when present in the composition, the inhibitor is typically present in an amount of from 0.0125 to 10 wt. % of the composition.

In one embodiment the inhibitor, when present, is selected from 1-ethynyl-1-cyclohexanol (ETCH) and/or 2-methyl-3-butyn-2-ol and is present in an amount of greater than zero to 0.1 wt. % of the composition.

### Optional Compression Set Additives

Whilst compression set is not usually deemed a critical performance for typical thermally conductive applications such as silicone grease, silicone gel and gap fillers, standard thermally conductive silicone rubber compositions usually show very high compression set due to high loading of thermally conductive filler(s) in the compositions to achieve thermal conductivity. As discussed elsewhere when a thermally conductive silicone rubber composition is designed to generate high thermal conductivities of e.g. at least 1.5 W/mK, (measured in accordance with ASTM D7896—hot disk method), the level of thermally conductive filler required generally result in the pre-cured compositions having significantly increased viscosities causing impaired handling characteristics and additionally, upon cure, result in cured silicone-based products with poor physical properties. Whilst such products may be acceptable for some applications, industry is increasingly demanding compositions for the generation of cured materials which have both
(i) the desired high levels of thermal conductivity, and
(ii) required levels of physical properties, whereas previously one might expect either one or the other. The high amount of thermally conductive filler present in a thermally conductive silicone rubber composition has in the past significantly decreased the elasticity/resiliency of silicone rubber but the composition provided herein appears to overcome this issue. However, it was identified that if desired the inclusion of certain compression set additives in the composition have a significant improving effect on compression set. The compression set is measured herein in accordance with ASTM D395 and is the permanent deformation remaining after removal of a force that was applied to it. The term is often a property of interest when using elastomers. Compression set occurs when a material is compressed to a specific deformation, for a specified time, at a specific temperature. Compression set testing measures the ability of rubber to return to its original thickness after prolonged compressive stresses at a given temperature and deflection. As a rubber material is compressed over time, it loses its ability to return to its original thickness. This loss of resiliency (memory) may reduce the capability of an elastomeric gasket, seal or cushioning pad to perform over a long period of time. The resulting permanent set that a gasket may take over time may cause a leak; or in the case of a shock isolation pad, the ability to protect an accidentally dropped unit may be compromised. Compression set results for a material are expressed as a percentage. The lower the percentage, the better the material resists permanent deformation under a given deflection and temperature range. The compression set additive use herein may be selected from, for example, Dodecanedioic acid, bis[2-(2-hydroxy benzoyl)hydrazide], diphenyl sulfide, salicyloylaminotriazole, 1,2-di[-(3,5-di-tert-butyl-4-hydroxyp-henyl)propionyl]hydrazine, copper(II) phthalocyanine and mixtures thereof, such as Dodecanedioic acid, bis[2-(2-hydroxy benzoyl)hydrazide] and copper (II) phthalocyanine. The compression set additive, when present is added to the composition in an amount of from 0.01-5 wt. % of the composition, alternatively from 0.01-2 wt. % of the composition.

### Optional Reinforcing and Semi-Reinforcing Fillers

Whilst not preferred given the requirement herein for a high thermal conductivity in the composition herein, a further optional ingredient in the present composition is at least one silica or calcium carbonate reinforcing or semi-reinforcing filler.

When present, the silica reinforcing fillers maybe exemplified by precipitated silica, fumed silica and/or colloidal silicas. Preferably the silica reinforcing fillers are finely divided. The calcium carbonate may be precipitated calcium carbonate. Precipitated silica, fumed silica and/or colloidal silicas are particularly preferred because of their relatively high surface area, which is typically at least 50 m²/g (BET method in accordance with ISO 9277: 2010); alternatively, having surface areas of from 50 to 450 m²/g (BET method in accordance with ISO 9277: 2010), alternatively having surface areas of from 50 to 300 m²/g (BET method in accordance with ISO 9277: 2010), are typically used. All these types of silica are commercially available.

The silica reinforcing filler(s) are naturally hydrophilic and therefore may be treated with a treating agent to render them hydrophobic. In the present composition the treating agent may be component (d) the same treating agent as used for the thermally conductive fillers or may be surface treated with any suitable low molecular weight organosilicon compounds other than component (d) disclosed in the art applicable to prevent creping of thermally conductive silicone rubber compositions during processing. For example, organosilanes, polydiorganosiloxanes, or organosilazanes e.g., hexaalkyl disilazane and short chain siloxane diols. Specific examples include, but are not restricted to, silanol terminated trifluoropropylmethylsiloxane, silanol terminated vinyl methyl (ViMe) siloxane, silanol terminated methyl phenyl (MePh) siloxane, liquid hydroxyldimethyl-terminated polydiorganosiloxane containing an average from 2 to 20 repeating units of diorganosiloxane in each molecule, hydroxyldimethyl terminated phenylmethyl Siloxane, hexaorganodisiloxanes, such as hexamethyldisiloxane, divinyltetramethyldisiloxane; hexaorganodisilazanes, such as hexamethyldisilazane (HMDZ), divinyltetramethyldisilazane and tetramethyldi(trifluoropropyl)disilazane; hydroxyldimethyl terminated polydimethylmethylvinyl siloxane, octamethyl cyclotetrasiloxane, and silanes including but not limited to methyltrimethoxysilane, dimethyldimethoxysilane, vinyltrimethoxysilane, methyltriethoxysilane, vinyltriethoxysilane, chlrotrimethyl silane, dichlrodimethyl silane, trichloromethyl silane.

In one embodiment, the treating agent may be selected from silanol terminated vinyl methyl (ViMe) siloxane, liquid hydroxyldimethyl-terminated polydiorganosiloxane containing an average from 2 to 20 repeating units of diorganosiloxane in each molecule, hexaorganodisiloxanes, such as hexamethyldisiloxane, divinyltetramethyldisiloxane; hexaorganodisilazanes, such as hexamethyldisilazane (HMDZ), divinyltetramethyldisilazane and; hydroxyldimethyl terminated polydimethylmethylvinyl siloxane, octamethyl cyclotetrasiloxane, and silanes including but not limited to methyltriethoxysilane, dimethyldiethoxysilane and/or vinyltriethoxysilane. A small amount of water can be added together with the silica treating agent(s) as processing aid.

The surface treatment of untreated reinforcing fillers may be undertaken prior to introduction in the composition or in situ, i.e., in the presence of at least a portion of the other components of the composition herein by blending these components together at room temperature or above until the filler is completely treated. If the treating agent being used is component (d) described above, the reinforcing filler and the thermally conductive filler (component (c)) may be treated simultaneously. If separate filler treating agents are being used for the reinforcing filler and component (c) respectively they will need to be treated separately or sequentially.

Typically, any untreated reinforcing filler is preferably treated in situ with a treating agent in the presence of polydiorganosiloxane polymer (a) which results in the preparation of a silicone rubber base material which can subsequently be mixed with other components.

As previously discussed, the thermally conductive silicone rubber compositions as described herein comprise from 80 wt. % to 95 wt. %, alternatively from e.g., 85 wt. % to 95 wt. % of thermally conductive filler. When there is both thermally conductive filler and reinforcing filler present in the composition at least 80 wt. % of the composition is thermally conductive filler and the cumulative amount of thermally conductive filler and reinforcing filler when the latter is present is a maximum of 95 wt. %. Hence the optional reinforcing filler may be present in the composition in an amount of 15 wt. % providing the upper limit for the cumulative total is not exceeded. That said, preferably the only filler present in the composition is a thermally conductive filler (c).

### Optional Pigments/Colorants

The composition as described herein may further comprise one or more pigments and/or colorants which may be added if desired. The pigments and/or colorants may be coloured, white, black, metal effect, and luminescent e.g., fluorescent and phosphorescent.

Suitable white pigments and/or colorants include titanium dioxide, zinc oxide, lead oxide, zinc sulfide, lithophone, zirconium oxide, and antimony oxide.

Suitable non-white inorganic pigments and/or colorants include, but are not limited to, iron oxide pigments such as goethite, lepidocrocite, hematite, maghemite, and magnetite black iron oxide, yellow iron oxide, brown iron oxide, and red iron oxide; blue iron pigments; chromium oxide pigments; cadmium pigments such as cadmium yellow, cadmium red, and cadmium cinnabar; bismuth pigments such as bismuth vanadate and bismuth vanadate molybdate; mixed metal oxide pigments such as cobalt titanate green; chromate and molybdate pigments such as chromium yellow, molybdate red, and molybdate orange; ultramarine pigments; cobalt oxide pigments; nickel antimony titanates; lead chrome; carbon black; lampblack, and metal effect pigments such as aluminium, copper, copper oxide, bronze, stainless steel, nickel, zinc, and brass.

Suitable organic non-white pigments and/or colorants include phthalocyanine pigments, e.g. phthalocyanine blue and phthalocyanine green; monoarylide yellow, diarylide yellow, benzimidazolone yellow, heterocyclic yellow, DAN orange, quinacridone pigments, e.g. quinacridone magenta and quinacridone violet; organic reds, including metallized azo reds and nonmetallized azo reds and other azo pigments, monoazo pigments, diazo pigments, azo pigment lakes, β-naphthol pigments, naphthol AS pigments, benzimidazolone pigments, diazo condensation pigment, isoindolinone, and isoindoline pigments, polycyclic pigments, perylene and perinone pigments, thioindigo pigments, anthrapyrimidone pigments, flavanthrone pigments, anthanthrone pigments, dioxazine pigments, triarylcarbonium pigments, quinophthalone pigments, and diketopyrrolo pyrrole pigments.

The pigments and/or colorants, when present, are present in the range of from 2 wt. %, alternatively from 3 wt. %, alternatively from 5 wt. % of the composition to 15 wt. % of the composition, alternatively to 10 wt. % of the composition.

### Other Optional Additives

Another optional additive herein may include metal deactivators i.e., fuel additives and oil additives used to stabilize fluids by deactivating (usually by sequestering) metal ions, mostly introduced by the action of naturally occurring acids in the fuel and acids generated in lubricants by oxidative processes with the metallic parts of the systems e.g., dodecanedioic acid, bis[2-(2-hydroxybenzoyl)hydrazide].

Pot life extenders, such as triazole, may be used, but are not considered necessary in the scope of the present invention. The thermally conductive silicone rubber composition may thus be free of pot life extender.

Examples of flame retardants include aluminium trihydrate, chlorinated paraffins, hexabromocyclododecane, triphenyl phosphate, dimethyl methylphosphonate, tris(2,3-dibromopropyl) phosphate (brominated tris), and mixtures or derivatives thereof.

Hence, in one alternative, the present disclosure thus provides a thermally conductive silicone rubber composition, which comprises:
a) a polydiorganosiloxane having a degree of polymerisation of at least 2,500 calculated from the number average molecular weight determined by gel permeation chromatography and at least two unsaturated groups per molecule, which unsaturated groups are selected from alkenyl or alkynyl groups and which is present in the composition in an amount of from 4 wt. % to about 19 or 20 wt. % of the composition, alternatively from 5 to about 19 or 20 wt. % of the composition, alternatively from 5 to 17.5 wt. % of the composition, alternatively from 7.5 to 17.5 wt. % of the composition, alternatively the difference between 100 wt. % and the cumulative amount of all other ingredients present in the composition;
b) an organosilicon compound having at least two, alternatively at least three Si—H groups per molecule, component (b) present in an amount of from 0.1 to 10 wt. % of the thermally conductive silicone rubber composition, alternatively 0.1 to 7.5 wt. % of the thermally conductive silicone rubber composition, alternatively 0.5 to 7.5 wt. %, further alternatively from 0.5% to 5 wt. % of the thermally conductive silicone rubber composition.
c) at least one thermally conductive filler with a volume median particle diameter of between 0.1-100 micrometers (μm) measured by laser diffraction particle size analysis in an amount of from 80 to 95 wt. % of the composition, alternatively from 85 wt. % to 95 wt. %;
d) an organopolysiloxane filler treating agent having a degree of polymerisation of between 4 to 500 calculated from the number average molecular weight determined by gel permeation chromatography and comprising
   (i) at least one alkenyl group per molecule and
   (ii) at least one hydroxy group or at least one alkoxy group or a mixture of hydroxy and alkoxy groups per molecule;
in an amount of from 0.1-10% wt. of the composition, alternatively in an amount of from 0.1-5 wt. %, alternatively in an amount of from 0.25-5 wt. % of the composition, alternatively in an amount of from 0.25-2.5 wt. % of the composition; and
e) a hydrosilylation catalyst comprising or consisting of a platinum group metal or a compound thereof, in an amount dependent on the form/concentration in which the catalyst is provided, within the range of from 0.001 to 3.0 wt. % of the composition, alternatively from 0.001 to 1.5 wt. % of the composition, alternatively from 0.01-1.5 wt. %, alternatively 0.01 to 0.1.0 wt. %, of the thermally conductive silicone rubber composition, providing the total wt. % of the composition is 100 wt. %. The composition may also contain one or more of the above optional additives in amounts indicated again providing the total wt. % of the composition is 100 wt. %.

Mixtures of the aforementioned components (a), (b), and (e) may begin to cure at ambient temperature. Hence, the thermally conductive silicone rubber compositions as hereinbefore described may be stored in two parts which are mixed together immediately before use when the composition is not prepared for immediate use. In such a case, the two parts are generally referred to as Part (A) and Part (B) and are designed to keep components (b) the cross-linker(s) and (e) the catalyst(s) apart to avoid premature cure.

Typically, in such cases a Part A composition will comprise components (a), (c), (d) and (e) and Part B will comprise components (a), (b), (c) and (d) and when present, inhibitor.

Other optional additives, when present in the composition, may be in either Part A or Part B providing they do not negatively affect the properties of any other component (e.g., catalyst inactivation). The part A and part B of a thermally conductive silicone rubber composition are mixed together shortly prior to use to initiate cure of the full composition into a silicone elastomeric material. The compositions can be designed to be mixed in any suitable weight ratio e.g., part A: part B may be mixed together in weight ratios of from 100:1 to 1:150 most preferred is a weight ratio of 1:100. Typically, the part A and part B compositions are mixed together using a two-roll mill or kneader mixer.

Components in each of Part A and/or Part B may be mixed together individually or may be introduced into the composition in pre-prepared in combinations for, e.g., ease of mixing the final composition. For example, components (a) and (c) may be mixed together to form a base composition. In such cases component (d) the treating agent is usually introduced into the mixture so that the thermally conductive filler (c) can be treated in-situ. Alternatively, the thermally conductive filler (c) may be pre-treated with component (d) although this is not preferred. The resulting base material can be split into two or more parts, typically part A and part B and appropriate additional components and additives may be added, if and when required.

Alternatively, the composition herein may be prepared by combining all of components together at ambient temperature into a one-part composition in cases where the composition is to be used immediately. Typically, a base is prepared first to enable the thermally conductive fillers to be treated in-situ and then the remaining ingredients can be introduced into the mixture in any suitable order.

Any mixing techniques and devices described in the prior art can be used for this purpose. The particular device to be used will be determined by the viscosities of components and the final curable coating composition. Suitable mixers include but are not limited to paddle type mixers e.g., planetary mixers and kneader type mixers. However, when component (a) is a gum mixing is preferably undertaken, as previously indicated using a two-roll mill or a kneader mixer. Cooling of components during mixing may be desirable to avoid premature curing of the composition.

Hence, in the case of a process for the manufacture of a one part thermally conductive silicone rubber composition as hereinbefore described the process may comprise the steps of
(i) preparing a hydrophobically treated thermally conductive filler base by mixing together components (a) and (c) together with treating agent (d) at a temperature in the range of from 75° C. to 150° C., alternatively from 80° C. to 140° C., alternatively 90° C. to 130° C. for a period of from 30 minutes to 2 hours, alternatively 40 minutes to 2 hours, alternatively of from 45 minutes to 90 minutes, to ensure the thermally conductive filler is in-situ treated with component (d) and thoroughly mixed into component (a) and then cooling the resulting base to approximately room temperature (23° C. to 25° C.)
(ii) introducing component (e) the catalyst (catalyst composition e.g., Karstedt's catalyst) component (c) cross-linker(s) and if desired optional inhibitor (e.g., Ethynyl Cyclohexanol (ETCH)) and any other optional additives in any suitable order, or simultaneously and mixing to homogeneity.

Once prepared because of the reactivity of the components (a), (b) and (e) the composition will cure. Typically, cure will take place at a temperature between 80° C. and 180° C., alternatively between 100° C. and 170° C., alternatively between 120° C. and 170° C. This may take place in any suitable manner for example, the composition may be introduced into a mold and is then press cured for a suitable period of time, e.g., from 2 to 10 minutes or as otherwise desired or required. The present thermally conductive silicone rubber composition may alternatively be further processed by injection moulding, encapsulation moulding, press moulding, dispenser moulding, extrusion moulding, transfer moulding, press vulcanization, centrifugal casting, calendaring, bead application or blow moulding. As and when required samples may be additionally post-cured by heating to a temperature of 130° C. to 200° C. for up to 4 Hours.

In the case of a process for the manufacture of a two part thermally conductive silicone rubber composition as hereinbefore described the process may comprise the steps
(i) the same as step (i) for the preparation of the one-part composition above,
(ii) dividing the resulting mixture into two parts, part A and part B and introducing the catalyst (e) into part A and the cross-linker and inhibitor (if present) in the part B composition.
(iii) Introducing any other optional additives into either or both part A and part B;
(iv) Storing the part A and part B compositions separately.

Typically, when utilised the part A and part B compositions are thoroughly mixed in a suitable weight ratio as described above, e.g., in a weight ratio of about 1:100 immediately before use in order to avoid premature cure. Cure is then undertaken as described above for the one-part composition.

The thermally conductive silicone rubber composition as hereinbefore described may be used in any suitable application for which prior art thermally conductive silicone rubber compositions are utilised.

It was surprisingly identified that the use of component (a) having a degree of polymerisation of at least 2,500 and consequently having a high viscosity and molecular weight in conjunction with a thermally conductive filler (component (c)) which is treated with a specific organopolysiloxane (component (d) was able to consistently achieve a hydrosilylation cured silicone rubber of high mechanical strength even when the composition contains very high amounts (80 to 95 wt. % of the composition or 85 to 95 wt. %) of thermally conductive filler (c).

Thermally conductive silicone rubber compositions may be used in a wide variety of applications, including for the sake of example in automotive and electronics applications including heat transfer pads for electric vehicles (EVs) Charger, heat transfer gaskets for EVs, under hood cooling parts for EVs, heat transfer pads for keypads, printed circuit boards (PCBs), central processing units (CPUs) and hard drives, heat dissipation parts for motor drive module and control module, heat dissipation parts for imaging display section of light emitting diode (LED) projectors, image processing module of security surveillance cameras, heat dissipation parts for broadband cellular networks, e.g. 5G (fifth generation technology standard for broadband cellular networks) and communication electronics devices.

### EXAMPLES

All viscosities were measured at 25° C. unless otherwise indicated. Viscosities of individual components in the following examples were measured using a Brookfield DV-III Ultra Programmable Rheometer for viscosities greater than or equal to 50,000 mPa·s, and a Brookfield DV 3T Rheometer for viscosities less than 50,000 mPa·s, unless otherwise indicated.

A series of compositions for examples and comparative Examples were prepared and are depicted in Tables 1a and 1b.

TABLE 1a
Composition of Examples Ex. 1 to 4 and Comparative Examples C. 1 to C. 3 in wt. %.

| Ingredient Type | C. 1 | C. 2 | C. 3 | Ex. 1 | Ex. 2 | Ex. 3 | Ex. 4 |
|---|---|---|---|---|---|---|---|
| Silicone Gum 1 | 9.927 | 9.9270 | 9.772 | 9.781 | 9.821 | 14.821 | 9.821 |
| Alumina | 89.00 | 89.00 | 89.00 | 89.00 | 89.00 | 84.00 | 35.50 |
| Aluminum nitride | | | | | | | 53.50 |
| Hexamethyldisilazane | 1.00 | | | | | | |
| Comp. Treatment Agent 1 | | 1.00 | | | | | |
| Tetramethyldivinyldisilazane | | | 1.00 | | | | |
| Treatment Agent 1 | | | | 1.00 | | | |
| Treatment Agent 2 | | | | | 1.00 | 1.00 | 1.00 |
| SiH crosslinker | 0.042 | 0.042 | 0.197 | 0.188 | 0.148 | 0.148 | 0.148 |
| Karstedt's Catalyst | 0.024 | 0.024 | 0.024 | 0.024 | 0.024 | 0.024 | 0.024 |
| ETCH | 0.007 | 0.007 | 0.007 | 0.007 | 0.007 | 0.007 | 0.007 |

Silicone gum 1 was a dimethylvinyl terminated polydimethylsiloxane having a DP of 5840 and Williams plasticity of 150 mm/100 in accordance with ASTM D-926-08.

The alumina used in the examples was the ADM-40K grade from Denka Company Limited which is a spherical form of alumina with a volume median particle diameter size of 40 μm (manufacturer's information).

The aluminum nitride used in the examples was the ANF S-80 ST204 grade from MARUWA CO., LTD which is a spherical form of aluminium nitride with a volume median particle diameter size of 80 μm (manufacturer's information).
Comparative Treatment Agent 1 is (CH₃)₃SiO[(CH₃)₂SiO]₁₁₀Si(OCH₃)₃

Treatment Agent 1 dimethyl hydroxy terminated Dimethyl, methylvinyl siloxane having a DP of between 4-17.
Treatment Agent 2 (CH₂═CH)(CH₃)₂SiO[(CH₃)₂SiO]₂₅Si(OCH₃)₃

Si—H cross-linker 1 was a trimethyl terminated Dimethyl, methylhydrogen siloxane having a viscosity of approximately 15 mPa·s at 25° C.

The Si—H/vinyl molar ratio for comparative Examples C.1, C.2 and C.3 was 1.6:1.

ETCH is Ethynyl Cyclohexanol.

TABLE 1b
Composition of Examples Ex. 5 and 6 and Comparative
Examples C. 4 to C. 6 in wt. %.

| Ingredient Type | C. 4 | C. 5 | C. 6 | Ex. 5 | Ex. 6 |
|---|---|---|---|---|---|
| Silicone Gum 1 | 9.76 | 9.80 | | 9.872 | 14.812 |
| Siloxane Polymer 1 | | | 9.863 | | |
| Alumina | 87.80 | 88.24 | 88.82 | 88.86 | 83.92 |
| Treatment Agent 2 | 0.98 | 0.98 | 0.99 | 0.99 | 0.99 |
| Bis-(2,4- | 1.46 | | | | |
| dichlorobenzoyl) | | | | | |
| Peroxide | | | | | |
| 2,5-Dimethyl-2,5-di(t- | | 0.98 | | | |
| butylperoxyl)hexane | | | | | |
| Si—H cross-linker 1 | | | 0.296 | 0.247 | 0.247 |
| ETCH | | | 0.007 | 0.007 | 0.007 |
| Karstedt's Catalyst | | | 0.024 | 0.024 | 0.024 |

Siloxane Polymer 1 is a dimethylvinyl terminated polydimethylsiloxane having a DP of 920 and a viscosity of 6,000 mPa·s at 25° C.

The Si—H/vinyl molar ratio for comparative Examples C.6 and Ex. 5 and Ex. 6 was 2.6:1.

The compositions were prepared by first preparing a base by loading silicone gum 1 of component (a) with the thermally conductive filler and the filler treating agent into a 5 L lab kneader mixer step by step and then mixing to homogeneity for about an hour at 120° C. for 1 hour. The resulting base was then allowed to cool to room temperature. Once cooled the Si—H cross-linker, Karstedt's catalyst and hydrosilylation cure inhibitor were added and mixed into the composition. In the case of comparative examples C.4 and C.5 the respective peroxide catalysts were introduced instead of the Si—H cross-linker, Karstedt's catalyst and hydrosilylation cure inhibitor.

The resulting compositions were then compression molded by means of a press cure apparatus. In the cases of Ex. 5, Ex. 6, C.4 and C.6 the curing process was 10 minutes at 120° C. for samples 2 mm thick and 20 minutes at 120° C. for 6 mm slabs. In the case of C.5 (due to the catalyst used the curing process was 10 minutes at 170° C. for samples 2 mm thick and 20 minutes at 170° C. for 6 mm slabs. In the case of thermal conductivity testing a series of examples and comparative examples were post cured for four hours at 200° C. The physical property results are provided in Tables 2a and 2c and the thermal conductivity results are provided in Tables 2c and 2d.

TABLE 2a
Physical property/performance after cure at 120° C. for 10 minutes

| Tested Property | C. 1 | C. 2 | C. 3 | Ex. 1 | Ex. 2 | Ex. 3 | Ex. 4 |
|---|---|---|---|---|---|---|---|
| Hardness (Shore A, ASTM D2240) | 70 | 73 | 90 | 84 | 87 | 70 | 90 |
| Tensile strength (MPa, ASTM D412) | 0.92 | 0.97 | 3.42 | 2.33 | 4.13 | 3.44 | 3.86 |
| Elongation at Break (%, ASTM D412) | 61 | 70 | 52 | 103 | 100 | 171 | 93 |
| Modulus 100% (MPa, ASTM D412) | | | | 2.32 | | 2.31 | |
| Tear strength (kN/m, ASTM D624 DIE C) | 4.09 | 5.12 | 8.46 | 7.63 | 9.87 | 8.29 | 7.51 |
| Specific Gravity (g/cm³, ASTM D792) | 2.923 | 2.863 | 2.922 | 2.867 | 2.867 | 2.592 | 2.494 |

TABLE 2b
Thermal Conductivity after cure at 120°
C. for 20 minutes (W/mK, Hot Disk, ASTM D7896)

| | C. 1 | C. 2 | C. 3 | Ex. 1 | Ex. 2 | Ex. 3 | Ex. 4 |
|---|---|---|---|---|---|---|---|
| Non-post cure samples | 2.805 | 2.628 | 2.892 | 2.648 | 2.708 | 1.656 | 4.132 |
| Post cure samples | 2.813 | 2.655 | 2.896 | 2.573 | 2.659 | 1.633 | 4.056 |

TABLE 2c
Physical property/performance after cure at 120° C. for 10 minutes

| Tested Property | C. 4 | C. 5 | C. 6 | Ex. 5 | Ex. 6 |
|---|---|---|---|---|---|
| Hardness (Shore A, ASTM D2240) | 91 | 88 | 91 | 85 | 67 |
| Tensile strength (MPa, ASTM D412) | 3.83 | 3.49 | 3.52 | 3.64 | 3.01 |
| Elongation at Break (%, ASTM D412) | 29 | 51 | 23 | 107 | 186 |
| Modulus 100% (MPa, ASTM D412) | | | | 3.55 | 1.89 |
| Tear strength (kN/m, ASTM D624 DIE C) | 10.04 | 11.21 | 12.68 | 9.42 | 8.35 |
| Specific Gravity (g/cm³, ASTM D792) | 2.846 | 2.872 | 2.895 | 2.858 | 2.585 |

TABLE 2d
Thermal Conductivity after cure at 120° C. for 20 minutes
(W/mK, Hot Disk, ASTM D7896)

| | C. 4 | C. 5 | C. 6 | Ex. 5 | Ex. 6 |
|---|---|---|---|---|---|
| Non-post cure samples | 2.535 | 2.771 | 2.997 | 2.641 | 1.670 |
| Post cure samples | 2.565 | 2.836 | 2.684 | 2.550 | 1.595 |

It can be seen that unlike the comparative examples the resulting cured silicone-based products of the Examples above provided a high thermal conductivity of e.g., at least 1.5 W/mK (measured in accordance with ASTM D7896—hot disk method) whilst retaining sufficient physical properties (i.e., tensile strength of at least 2 MPa and elongation at break of at least 80% in accordance with ASTM D412). Furthermore, with slightly more thermally conductive filler present e.g., at least 85 wt. % examples provided a thermal conductivity of e.g., at least 2.0 W/mK (measured in accordance with ASTM D7896—hot disk method) whilst retaining sufficient physical properties (i.e., tensile strength of at least 2 MPa and elongation at break of at least 80% in accordance with ASTM D412).

### Compression Set

In the following Examples and Compression Set Examples (Cs Ex.) it was found that the use of certain additives significantly reduced the compression set of compositions herein to less than 30% (ASTM D395), whilst retaining both high thermal conductivity and physical properties as described above. Composition prepared are depicted in Tables 3a, 3b and 3c. all processes for making the compositions are in accordance with the above. Samples were also cured in the same fashion.

TABLE 3a
Composition of Ex. 7 & 8 and Compression set
Examples Cs Ex. 1, 2 and 3 in wt. %.

| Ingredient | | | | | |
|---|---|---|---|---|---|
| Type | Ex. 7 | Ex. 8 | Cs Ex. 1 | Cs Ex. 2 | Cs Ex. 3 |
| Silicone | 14.8210 | 9.8710 | 9.8710 | 9.8610 | 9.8110 |
| Gum 1 | | | | | |
| Alumina | 84.00 | 88.95 | 88.94 | 88.91 | 88.51 |
| Treatment | 1.00 | 1.00 | 1.00 | 1.00 | 1.00 |
| Agent 2 | | | | | |
| Si—H cross- | 0.148 | 0.148 | 0.148 | 0.148 | 0.148 |
| linker 1 | | | | | |
| ETCH | 0.007 | 0.007 | 0.007 | 0.007 | 0.007 |
| Karstedt's | 0.024 | 0.024 | 0.024 | 0.024 | 0.024 |
| Catalyst | | | | | |
| Compression | | | 0.01 | 0.05 | 0.50 |
| Set | | | | | |
| Additive 1 | | | | | |

Compression set Additive 1 was Dodecanedioic acid, bis[2-(2-hydroxy benzoyl)hydrazide]. The Si—H/vinyl molar ratio for the Examples and comparative Examples in Table 3a was 1.6:1.

TABLE 3b
Composition of Ex. 9 and Compression
set Examples Cs Ex 4-7 in wt. %.

| | | Cs | Cs | Cs | Cs |
|---|---|---|---|---|---|
| Ingredient Type | Ex. 9 | Ex. 4 | Ex. 5 | Ex. 6 | Ex. 7 |
| Silicone Gum 1 | 9.877 | 9.877 | 9.417 | 9.851 | 9.818 |
| Alumina | 88.98 | 88.97 | 88.94 | 88.76 | 88.54 |
| Treatment Agent 2 | 1.00 | 1.00 | 1.00 | 1.00 | 1.00 |
| Si—H cross-linker 1 | 0.112 | 0.112 | 0.112 | 0.111 | 0.111 |
| ETCH | 0.007 | 0.007 | 0.007 | 0.007 | 0.007 |
| Karstedt's Catalyst | 0.024 | 0.024 | 0.024 | 0.024 | 0.024 |
| Compression Set | | 0.01 | 0.50 | | |
| Additive 1 | | | | | |
| Compression Set | | | | 0.25 | 0.50 |
| Additive 2 | | | | | |

Compression set additive 2 was a 2:3 weight ratio of Copper(II) phthalocyanine in a dimethylvinyl terminated polydimethylsiloxane having a viscosity of 10,000 mPa·s, at 25° C.

The Si—H/vinyl molar ratio for the Examples and comparative Examples in Table 3b was 1.2:1.

TABLE 3c
Composition of comparatives C. 7 & 8, Ex. 11 and Compression
set Examples Cs Ex. 8 and 9 in wt. %.

| | | | | Cs | Cs |
|---|---|---|---|---|---|
| Ingredient Type | C. 7 | Ex. 11 | C. 8 | Ex.8 | Ex.9 |
| Silicone Gum 1 | 9.886 | 9.882 | 9.866 | 9.872 | 9.867 |
| Alumina | 89.04 | 89.01 | 88.96 | 88.92 | 88.89 |
| Comp. Treatment | 1.00 | 0.50 | 1.00 | 0.50 | |
| Agent 1 | | | | | |
| Treatment Agent 2 | | 0.50 | | 0.50 | 1.00 |
| Si—H cross-linker 1 | 0.043 | 0.077 | 0.043 | 0.077 | 0.112 |
| ETCH | 0.007 | 0.007 | 0.007 | 0.007 | 0.007 |
| Karstedt's | 0.024 | 0.024 | 0.024 | 0.024 | 0.024 |
| Catalyst | | | | | |
| Compression Set | | | 0.10 | 0.10 | 0.10 |
| Additive 1 | | | | | |

The Si—H/vinyl molar ratio for the Examples and comparative Examples in Table 3b was 1.2:1. The physical property results of the different examples, comparatives and compression Set Examples were obtained as described above.

TABLE 4a
Physical properties (120° C./10 min) property/performance table.

| Tested Property | Ex. 7 | Ex. 8 | Cs Ex.1 | Cs Ex.2 | Cs Ex.3 |
|---|---|---|---|---|---|
| Hardness (Shore A, ASTM D2240) | 70 | 87 | 86 | 86 | 87 |
| Tensile strength (MPa, ASTM D412) | 3.44 | 4.13 | 3.98 | 3.99 | 3.90 |
| Elongation at Break (%, ASTM D412) | 171 | 99 | 95 | 99 | 101 |
| Tear strength (kN/m, ASTM D624 DIE C) | 8.29 | 9.87 | 9.93 | 9.83 | 9.92 |

TABLE 4b
Thermal Conductivity and Compression set results

| Tested Property | Ex. 7 | Ex. 8 | Cs Ex.1 | Cs Ex.2 | Cs Ex.3 |
|---|---|---|---|---|---|
| Thermal Conductivity (W/mK, Hot Disk, | 1.66 | 2.71 | 2.62 | 2.58 | 2.55 |
| ASTM D7896) | | | | | |
| Compression Set (%, 175° C./ | 43 | 56 | 29 | 16 | 15 |
| 22 h, ASTM D395) | | | | | |

It will be appreciated that whilst Ex. 7 and 8 provide results in accordance with the disclosure herein their compression set results are greater than 30%. However, with the introduction of compression set additive 1 the compression set examples have a compression set of less than 30%.

The loading level of compression set additive 1 has an impact on the compression set. Higher levels of additive 1 lead to lower compression set. Thus, using the compression set additives herein result in a compression set of less than or equal to 30% which is the sort of values required for connector seals used in automotives for sealing purposes. This thermally conductive silicone composition not only has high thermal conductivity but also could provide good sealing performance], given the excellent compression set values.

TABLE 4c
Physical properties (120° C./10 min)

| Tested Property | Ex. 9 | Cs Ex. 4 | Cs Ex.5 | Cs Ex.6 | Cs Ex.7 |
|---|---|---|---|---|---|
| Hardness (Shore A, ASTM D2240) | 87 | 88 | 88 | 88 | 88 |
| Tensile strength (MPa, ASTM D412) | 4.02 | 4.18 | 4.28 | 4.10 | 4.08 |
| Elongation at Break (%, ASTM D412) | 86 | 87 | 94 | 87 | 89 |
| Tear strength (kN/m, ASTM D624 | 10.51 | 9.92 | 10.22 | 10.26 | 10.39 |
| DIE C) | | | | | |

TABLE 4d
Thermal Conductivity and Compression set results

| Tested Property | Ex. 9 | Cs Ex. 4 | Cs Ex.5 | Cs Ex.6 | Cs Ex.7 |
|---|---|---|---|---|---|
| Thermal Conductivity | 2.59 | 2.61 | 2.62 | 2.61 | 2.56 |
| (W/mK, Hot Disk, | | | | | |
| ASTM D7896) | | | | | |
| Compression Set | 40 | 17 | 8 | 24 | 24 |
| (%, 175° C./22 h, | | | | | |
| ASTM D395) | | | | | |

Likewise, it will be appreciated that whilst Ex. 9 provides results in accordance with the disclosure herein their compression set results are greater than 30%. However, with the introduction of compression set additive 1 or 2, the compression set examples have a compression set of less than 30%.

TABLE 4e
Physical properties (120° C./10 min)

| Tested Property | C. 7 | Ex. 11 | C. 8 | Cs Ex.8 | Cs Ex.9 |
|---|---|---|---|---|---|
| Hardness (Shore A, ASTM D2240) | 73 | 84 | 73 | 83 | 87 |
| Tensile strength (MPa, ASTM D412) | 0.97 | 2.26 | 1.04 | 2.37 | 4.00 |
| Elongation at Break (%, ASTM D412) | 70 | 110 | 135 | 118 | 91 |
| Tear strength (kN/m, ASTM D624 | 5.12 | 7.82 | 5.23 | 7.79 | 10.08 |
| DIE C) | | | | | |

TABLE 4f
Thermal Conductivity and Compression set results

| Tested Property | C. 7 | Ex. 11 | C. 8 | Cs Ex.8 | Cs Ex.9 |
|---|---|---|---|---|---|
| Thermal Conductivity (W/mK, | 2.63 | 2.62 | 2.62 | 2.72 | 2.62 |
| Hot Disk, ASTM D7896) | | | | | |
| Compression Set (%, 175° C./ | 68 | 48 | 73 | 21 | 7 |
| 22 h, ASTM D395) | | | | | |

In the case of C.7 and C.8, poor tensile strength and/or elongation results are evident in the absence of the treatment agent as described herein. When a proportion of treatment agent is introduced the Ex. 9 physical properties are acceptable but without the compression set additive have a compression set value greater than 30%. However, with the introduction of compression set additive 1 or 2, the compression set examples have a compression set of less than 30%.

1. A thermally conductive silicone rubber composition, which comprises the following components:
a) a polydiorganosiloxane having a degree of polymerisation of at least 2,500 calculated from the number average molecular weight determined by gel permeation chromatography and at least two unsaturated groups per molecule, which unsaturated groups are selected from alkenyl or alkynyl groups;
b) an organosilicon compound having at least two, optionally at least three Si—H groups per molecule;
(c) at least one thermally conductive filler with a volume median particle diameter of 0.1-100 micrometers (μm) measured by laser diffraction particle size analysis,
in an amount of from 80 to 95 wt. % of the composition;
d) an organopolysiloxane filler treating agent having a degree of polymerisation of from about 4 to 500 calculated from the number average molecular weight determined by gel permeation chromatography and comprising;
(i) at least one alkenyl group per molecule, and
(ii) at least one hydroxy group or at least one alkoxy group or a mixture of hydroxy and alkoxy groups per molecule;
in an amount of from 0.1-10% wt. of the composition; and
e) a hydrosilylation catalyst comprising or consisting of a platinum group metal or a compound thereof;
wherein the total wt. % of the composition is 100 wt. %.

2. The thermally conductive silicone rubber composition in accordance with claim 1, wherein component (a) has a degree of polymerisation of at least 4,000 determined by gel permeation chromatography.

3. The thermally conductive silicone rubber composition in accordance with claim 1, wherein when cured the composition provides a cured silicone-based products with a thermal conductivity of at least 1.5 W/mK, measured in accordance with ASTM D7896—hot disk method, whilst having a tensile strength of at least 2 MPa and elongation at break of at least 80% in accordance with ASTM D412.

4. The A-thermally conductive silicone rubber composition in accordance with claim 1, wherein component (c) comprises at least one thermally conductive filler with a volume median particle diameter size of 0.1-100 micrometers (μm) measured by laser diffraction particle size analysis, in an amount of from 85 to 95 wt. % of the composition.

5. The thermally conductive silicone rubber composition in accordance with claim 1, wherein when cured the composition provides a cured silicone-based product with a thermal conductivity of at least 2.0 W/mK, (measured in accordance with ASTM D7896—hot disk method, whilst having a tensile strength of at least 2 MPa and elongation at break of at least 80% in accordance with ASTM D412.

6. The thermally conductive silicone rubber composition in accordance with claim 1, stored before use in two parts, Part A and part B, to keep components (b) and (e) apart to avoid premature cure.

7. The thermally conductive silicone rubber composition in accordance with claim 6, wherein Part A comprises components (a), (c), (d) and (e) and Part B comprises components (a), (b), (c) and (d).

8. The thermally conductive silicone rubber composition in accordance with claim 1, which also comprises a cure inhibitor.

9. The thermally conductive silicone rubber composition in accordance with claim 1, which also comprises at least one compression set additive selected from Dodecanedioic acid, bis[2-(2-hydroxy benzoyl)hydrazide], diphenyl sulfide, salicyloylaminotriazole, 1,2-di[-(3,5-di-tert-butyl-4-hydroxyp-henyl)propionyl]hydrazine, copper(II) phthalocyanine and mixtures thereof.

10. A cured silicone-based product cured from the thermally conductive silicone rubber composition in accordance with claim 1.

11. The cured silicone-based product in accordance with claim 10, having a thermal conductivity of at least 1.5 W/mK, measured in accordance with ASTM D7896—hot disk method whilst having a tensile strength of at least 2 MPa and elongation at break of at least 80% in accordance with ASTM D412.

12. The cured silicone-based products in accordance with claim 11, having a thermal conductivity of at least 2.0 W/mK, measured in accordance with ASTM D7896—hot disk method, whilst having a tensile strength of at least 2 MPa and elongation at break of at least 80% in accordance with ASTM D412.

13. The cured silicone-based product in accordance with claim 10, having a compression set of less than 30% as measured in accordance with ASTM D395.

14. A method for the manufacture of automotive and electronics components, the method comprising providing the thermally conductive silicone rubber composition in accordance with claim 1.

15. The method in accordance with claim 14, wherein the automotive and electronics components are selected from in heat transfer pads for electric vehicle chargers, heat transfer gaskets for electric vehicles, under hood cooling parts for electric vehicles, heat transfer pads for keypads, printed circuit boards, central processing units and hard drives, heat dissipation parts for motor drive modules and control modules, heat dissipation parts for imaging display sections of light emitting diode projectors, image processing modules of security surveillance cameras, heat dissipation parts for broadband cellular networks, and communication electronics devices.
